(19) United States
(12) Patent Application Publication
(10) Pub. No.: US 2016/0193724 A1
(43) Pub. Date: Jul. 7, 2016

(54) Socket Spanner

(71) Applicant: Wera Werk Hermann Werner GmbH & Co. KG, Wuppertal (DE)

(72) Inventor: Michael Abel, Radevormwald (DE)

(21) Appl. No.: 15/068,193

(22) Filed: Mar. 11, 2016

Related U.S. Application Data
(63) Continuation of application No. PCT/EP2014/068470, filed on Sep. 1, 2014.

(30) Foreign Application Priority Data
Sep. 19, 2013 (DE) 102013015506.1

(51) Int. Cl. B25B 23/10; B25B 13/06

(52) U.S. Cl. CPC B25B 23/108; B25B 13/065

(57) ABSTRACT

A socket spanner including a drive head, which forms a polygonal profile opening that can be plugged onto a polygonal bolt head or a polygonal screw nut, and includes a retaining element enclosed in a window of the wall of the polygonal profile opening, which retaining element is acted on by a spring element arranged outside the wall. In order to simplify such a socket spanner in terms of manufacturing technology and/or to improve it in terms of handling, it is proposed that the spring element is a shrinkable tube which is shrink-fitted on the wall.

### TECHNICAL FIELD

The invention relates to a socket spanner comprising a drive head, which forms a polygonal profile opening, which can be plugged onto a polygonal bolt head or a polygonal screw nut, comprising a retaining element, which is enclosed in a window of the wall of the polygonal profile opening and which is acted on by a spring element, which is arranged outside the wall.

### BACKGROUND

DE 196 44 177 A1 describes a socket spanner, which has a drive shaft comprising a hexagonal profile and a drive head, wherein a polygonal opening is arranged in the front side of the drive head for plugging onto a polygonal screw head or a polygonal screw nut. A window, in which a sphere, the diameter of which is larger than the material thickness of the window, is inserted upstream of support shoulders, is located in one of the polygonal walls of the polygonal opening. The peripheral wall of the head has a peripheral groove, in which a spring ring is enclosed, which acts elastically on the sphere in radially inwardly direction, so that said sphere can yield elastically in radially outwardly direction when the socket spanner is attached to a bolt head and is pressed against a polygonal surface of the bolt head or of the screw nut by means of the reset force of the spring. The polygonal bolt head or the polygonal screw nut is held in the polygonal opening in a frictionally engaged manner by means of the sphere.

To avoid that the ring, which is open by a gap, rotates, so that the gap comes to rest above the sphere, so that the elastic reset function or the sphere is lost, respectively, the socket spanner has a captivation element in the form of a nose, which engages with a recess of the spring ring.

The socket spanner described by DE 20 2008 010206 U1 has a spring element, which has an annular shape and which engages through the window with an end, which is bent off in radially inwardly direction and which forms the pressure piece with this bent end.

EP 0 646 439 A1 describes a socket spanner, in the case of which a bent section of a spring leaf ring extends through the window into the polygonal opening so as to form the retaining element.

EP 1 010 157 B1 describes a screwdriver bit comprising a shrinkable tube, which is attached to the shaft between drive polygonal and operating point.

DE 196 28 901 C1 describes a screwdriver comprising a tubular blade, the end of which is shrink-fitted on a polygonal section of a bit.

A socket spanner, in the case of which a spring ring acts on the sphere, is also known from DE 84 29 029 U1 .

EP 1 180 417 A2 describes a socket spanner comprising a spring element, which is formed from a section of an extruded plastic profile.

### SUMMARY

The invention is based on the object of simplifying the above-mentioned socket spanner in terms of manufacturing technology or to improve it in terms of handling, respectively.

The object is solved by means of the invention specified in the claims.

Initially and substantially, it is proposed for the spring element to be a shrinkable tube, which is shrink-fitted on the wall. The shrinkable tube rests against the retaining element so as to contact it. Preferably, the retaining element is formed by a sphere, which leaves a bulge in the shrinkable hose, which consists of plastic. Preferably, the edge of the shrinkable hose thus bears on the bottom area of a peripheral groove, which is defined by edges, across its entire periphery. An optimized spring effect on the retaining element, which extends into the cross sectional profile of the polygonal profile opening area by area and which is moved radially outwardly when the polygonal profile opening is plugged onto a polygonal bolt head or onto a polygonal screw nut, thus develops. The bulge increases thereby. This creates force components inside the spring element, which are directed in peripheral direction, as well as force components, which extend in axial direction of the socket spanner, which are thus oriented from the edge of the shrinkable tube in the direction of the peak of the bulge. Tension lines, which run outwardly in a star-shaped manner, which create a force component in radial direction and which act on the retaining element against the polygonal profile (polygonal edge or polygonal edge surface) of the polygonal bolt head or of the polygonal screw nut, respectively, are formed, starting at the peak of the bulge.

Provision is made in a further development of the invention for the retaining element not to be adjacent to the edge of the polygonal profile opening on the side of the opening, but adjacent to the bottom-side edge of the polygonal profile opening on the bottom side. The edge of the polygonal profile opening on the side of the opening can thereby define an opening plane, and the edge of the polygonal profile opening can define a bottom plane. A center plane defines the center between bottom plane and opening plane. In general, the three planes run parallel to one another. In the alternative, the retaining element is located in the area between center plane and bottom plane.

Provision is made in a further alterative of the invention for two retaining elements to be provided. A first retaining element and a second retaining element can be arranged downstream from one another in axial direction. The first retaining element can be located in the area between opening plane and center plane. The second retaining element is preferably located between center plane and bottom plane. A retaining element, which is located in the area between opening plane and center plane, can captivate a screw nut, for example, which is inserted into the polygonal profile opening so as to screw the screw nut onto a threaded shaft. The retaining element located in the area between center plane and bottom plane is able to captivate a bolt head or a polygonal screw nut, after an axial force has been applied to the polygonal screw nut or the bolt head. In particular, the retaining element adjacent to the bottom is characterized in that it also captivates a bolt head, which is formed so as to be relatively flat and which rests with its front side against the bottom-side edge of the polygonal profile opening. The bolt head is thus oriented in such a manner that the screw shaft extends in axial direction of the socket spanner. This makes it easier to screw a screw into an internal thread.

Provision is made in a further development for a socket spanner, which is equipped with two retaining elements, to only have one spring element, which acts on both retaining elements in radial inwardly direction. This spring element can be formed by a shrinkable tube, which consists of plastic and which has a sufficient elasticity or material thickness, respectively, so as to act on the two retaining elements against a step of the window by forming one or two bulges, respectively.

### BRIEF DESCRIPTION OF THE DRAWINGS

Exemplary embodiments of the invention will be explained below by means of enclosed drawings:

FIG. 1 shows a perspective illustration of a first exemplary embodiment,

FIG. 2 shows the section according to line II-II in FIG. 1,

FIG. 3 shows the section according to line III-III in FIG. 2,

FIG. 4 shows a perspective illustration of a second exemplary embodiment,

FIG. 5 shows the section according to line V-V in FIG. 4,

FIG. 6 shows the section according to line VI-VI in FIG. 5,

FIG. 7 shows a perspective illustration of a third exemplary embodiment,

FIG. 8 shows the section according to line VIII-VIII in FIG. 7.

### DETAILED DESCRIPTION

The tools illustrated in the drawings are socket spanners 1, which consist of metal, in particular steel, and which form a drive head 2, in which a polygonal profile opening 10 is located. The polygonal profile opening 10 has six polygonal surfaces, each of which abut on one another at polygonal edges, which are rounded to form flutes.

The socket spanner 1 has a drive shaft 3, which is embodied as sleeve section in the exemplary embodiment. The sleeve section has a drive opening 11, which also has a polygonal profile. In the exemplary embodiment, it is a square profile. However, the drive shaft 3 can also be embodied as polygonal profile shaft, which can be inserted into a polygonal opening of a chuck. In the case of the exemplary embodiment, a square drive, for example of a ratchet handle, can be inserted into the drive opening 11. The socket spanner 1 described in the exemplary embodiments is also referred to as socket.

One or a plurality of windows 7, 7′, in each of which a retaining sphere 8, 8′ is enclosed, is/are located in a wall 12 of the polygonal profile opening 10, in particular in a surface section of the polygonal profile. The opening of the window 7, which points to the polygonal profile opening 10, forms a step 14, against which a peripheral section of the sphere 8, 8′ can be supported, so that the sphere 8, 8′ dips into the polygonal profile opening 10 only with a section.

A spring element 9, 9″ is supported against the sphere section, which is located opposite the section of the sphere 8, which dips into the polygonal profile opening 10. This spring element 9, 9″ deploys a force on the sphere 8, 8″, which is directed radially inwardly.

If a hexagonal profile section, for example a polygonal screw nut or a polygonal bolt head, is inserted into the polygonal profile opening 10, the sphere 8, 8′ is pushed radially outwardly. This occurs against a reset force, which is applied by the spring element 9, 9′. The attachment of the sphere 8, 8′ on the polygonal profile of the screw nut or of the bolt head creates a frictional force, which fixes the screw nut or the bolt head in the polygonal profile opening. The screw nut or the bolt head is secured against falling out of the polygonal profile opening 10, so that the screw nut or the screw, respectively, can be handled.

The opening edge 10′ of the polygonal profile opening 10 is located in an opening plane Ö. The bottom-side edge 10″ of the polygonal profile opening 10 is located in a bottom plane B. In the case of the exemplary embodiment, the bottom-side edge 10″ does not adjoin a physically embodied, closed bottom, but against a cross sectional tapering of the polygonal profile opening 10. The bottom edge 10″ forms a stop shoulder, against which the polygonal profile 10 of a screw nut or of a bolt head, which is inserted into the polygonal profile opening 10, can be supported. The screw nut or the bolt head is then located with its broad side in the bottom plane B, so that the axis of the thread opening of the screw nut or the axis of the thread shaft of the screw, respectively, is located in the axis A of the socket spanner 1.

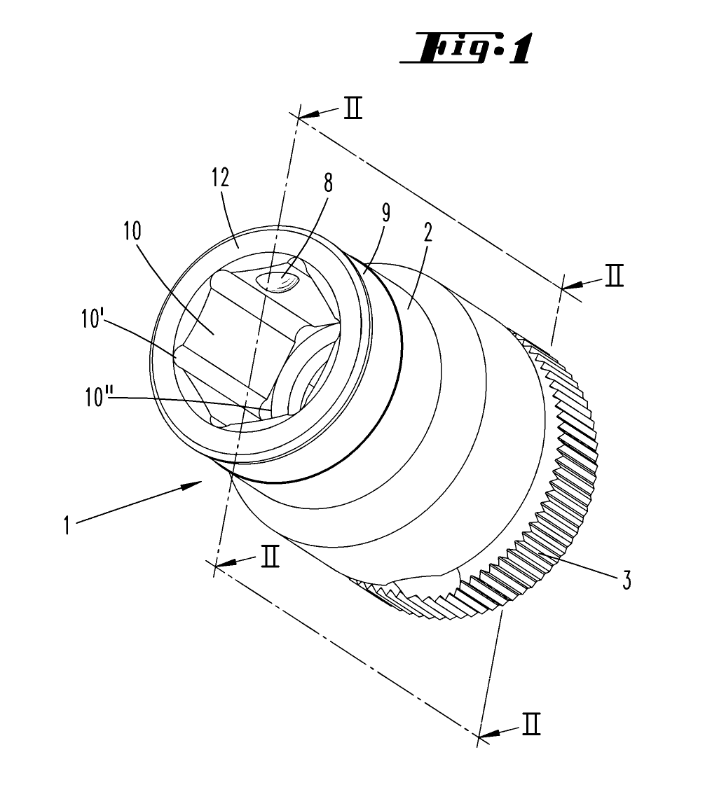

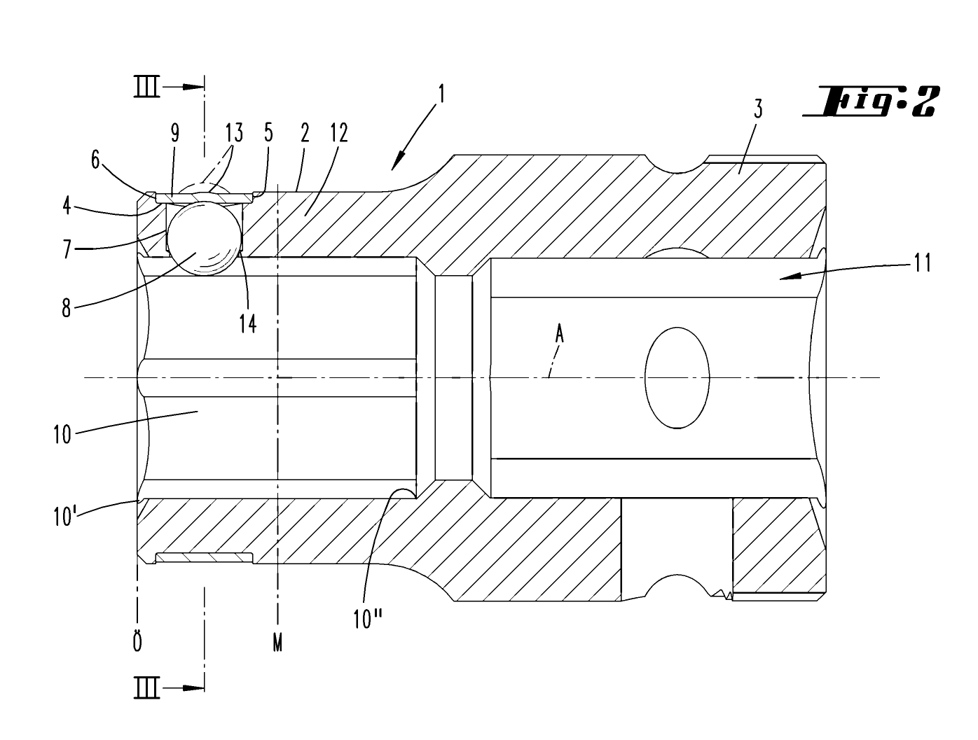

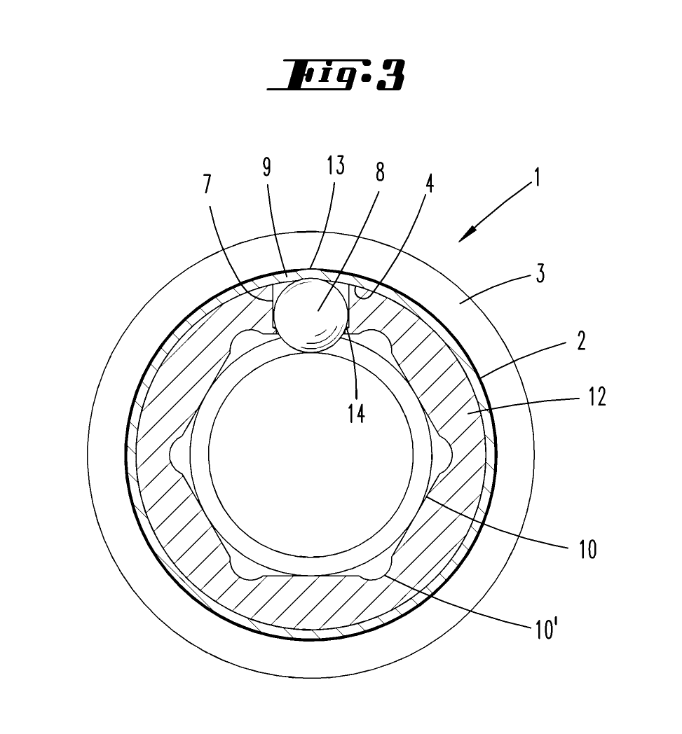

In the case of the first exemplary embodiment, which is illustrated in FIGS. 1 to 3, the spring element 9 is formed by a shrinkable tube. The shrinkable tube, which consists of plastic, is shrink-fitted on the wall 12. The wall 12 has a peripheral groove 4, which is defined by edges 5, 6. The shrinkable tube has a width, which substantially completely fills the width of the peripheral groove 4. The two edges of the shrinkable tube 9 are thus in contacting or virtually contacting application, respectively, with the edges 5, 6 of the peripheral groove 4. The material thickness of the shrinkable tube 9 corresponds approximately to the depth of the peripheral groove 4. Preferably however, the material thickness of the shrink-fitted shrinkable tube 9 is slightly less than the depth of the peripheral groove 4 or the height of the edges 5, 6, respectively. The sphere 8, which is stepped on the step 14, extends with a rounding section beyond the bottom plane of the peripheral groove 4 and thus creates a bulge 13, which is oriented radially outwardly, in the shrinkable tube 9. The sphere 8 is in contacting application with the inner wall of the shrinkable tube 9. The bulge 13 thus forms the curvature progression of the sphere 8. Preferably, both edges of the shrinkable tube 9 are in contacting application with the bottom of the peripheral groove 4 across the entire periphery. The window 7 is thus closed all-around in radial outward direction by means of the shrinkable tube 9.

If a screw nut or a bolt head is inserted into the polygonal profile opening 10, the sphere 8 is moved in radial outward direction. The bulge 13 increases thereby. Said bulge is illustrated in a dot-dashed manner in the drawings.

In the case of the exemplary embodiment illustrated in FIGS. 1 to 3, the sphere 8 is located in the area between opening plane Ö and center plane M.

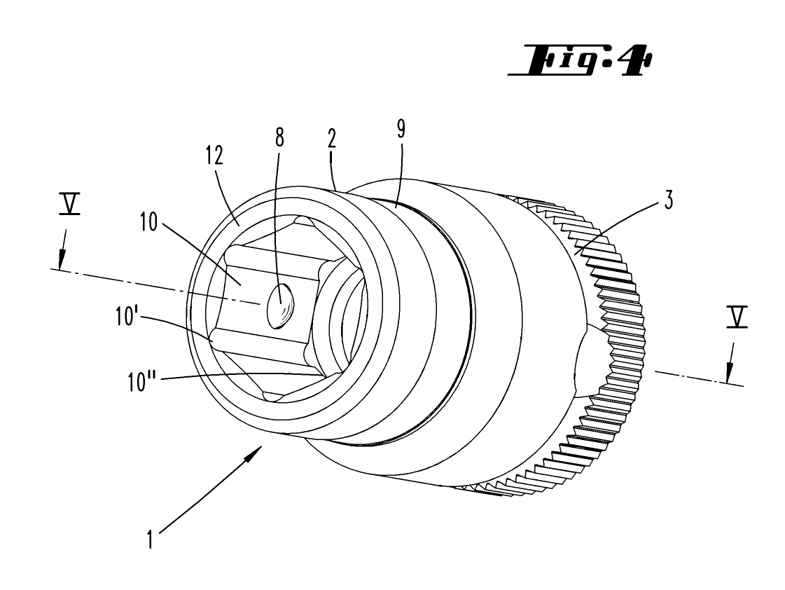

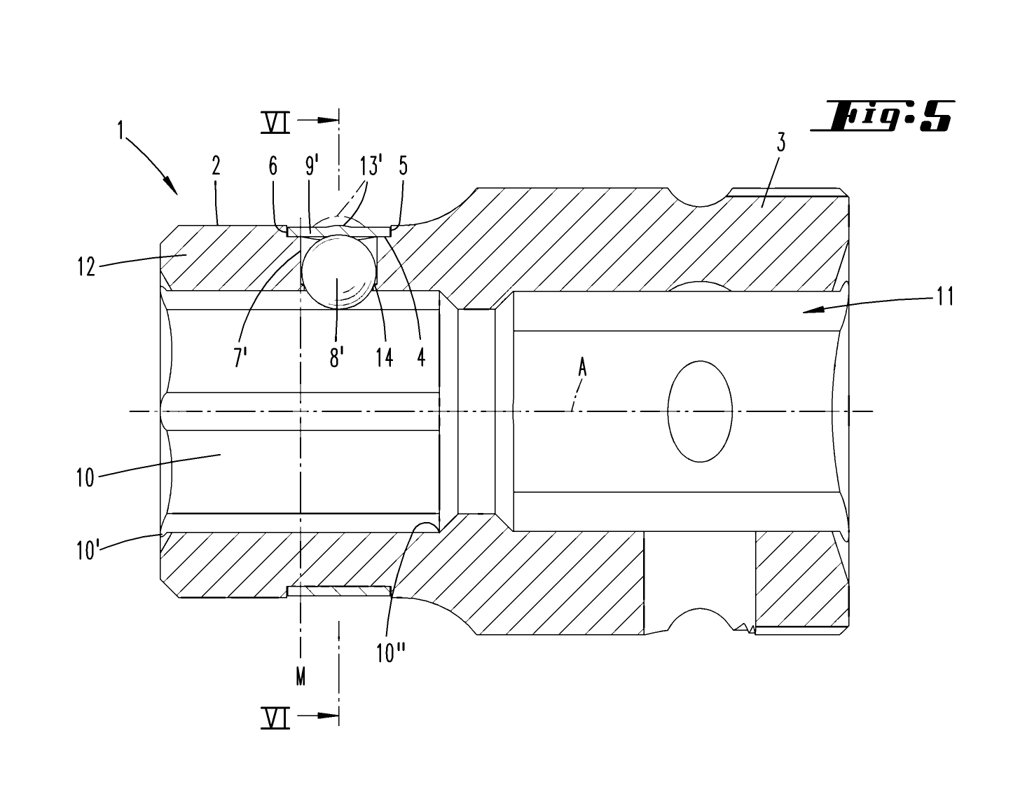

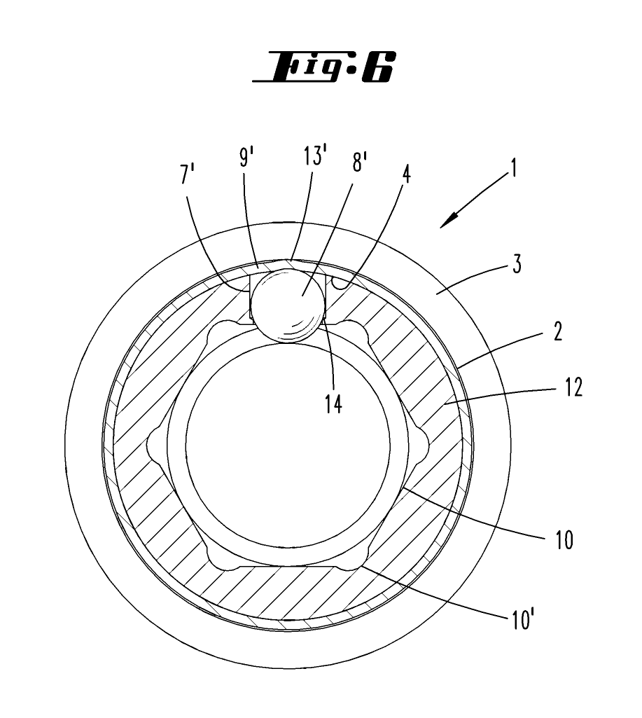

In the case of the exemplary embodiment illustrated in FIGS. 4 to 6, the sphere 8′ is located in the area between center plane M and bottom plane B. The sphere 8′ is also spring-loaded here by a shrinkable tube 9′. The same geometric ratios as in the case of first exemplary embodiments prevail, so that the sphere 8′, which is supported on the step 14, forms a bulge 13′, which increases when a polygonal profile is inserted. By means of this exemplary embodiment, the screw shaft of a screw, which is inserted into the polygonal profile opening 10, can be retained coaxially to the axis A. The bolt head is thereby located in the bottom plane B with its front surface. The sphere 8′ is supported on the polygonal profile section of the bolt head.

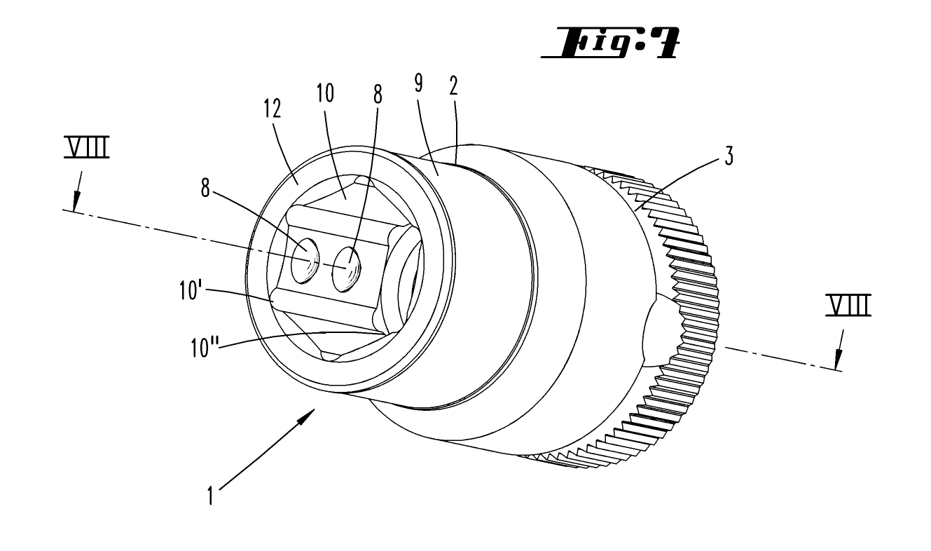

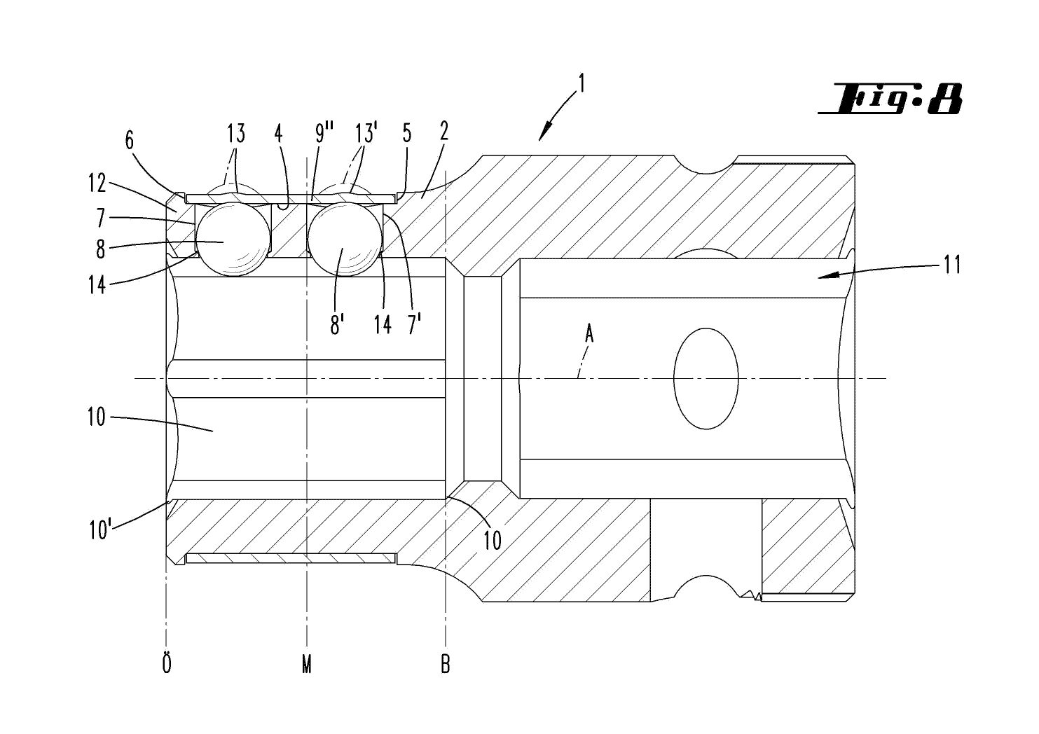

To some extent, the third exemplary embodiment illustrated in FIGS. 7 and 8 is a combination of the two above-described exemplary embodiments, because the socket spanner 1 forms two windows 7, 7′, which are arranged downstream from one another in axial direction. With regard to its position, the window 7 corresponds to the position of the window 7 of the first exemplary embodiment. With regard to its position, the window 7′ corresponds to the position of the window 7′ of the second exemplary embodiment. The polygonal profile opening 10 has two halves, which are located axially downstream from one another, namely an opening-side half between opening plane Ö and center plane M, and a bottom-side half between center plane M and bottom plane B. In the case of the exemplary embodiment, a sphere 8, 8′ is in each case located in one of the two halves.

Here, the peripheral groove 4 extends in axial direction across both windows 7, 7′, so that the shrinkable tube 9″, which is enclosed in the peripheral groove 4, applies a force to both spheres 8, 8′ together. Two bulges 13, 13′ are formed at that location, because the shrinkable tube 9, 9′ acts directly on the sphere here as well. Here, the shrinkable tube 9′ also has an axial width, which corresponds to the axial width of the peripheral groove 4. The bulges 13, 13′ are spatially spaced apart from one another.

In the described exemplary embodiments, the spring element 9, 9′, 9″ acts directly on the retaining element 8, 8′. However, provision is also made for a pressure transfer element, on which the spring element 9, 9′, 9″ acts directly, to be arranged between retaining element 8, 8′. Such a pressure transfer element can be a pressure transfer disk, for example, which rests against the inner wall of a shrinkable tube 9, 9′, 9″ radially on the outside and which acts against a retaining element 8, 8′, 8″ with its broad side, which is oriented radially inwardly. The retaining element can be a sphere. However, it can also be a pressure piece, which is formed differently, which is in particular supported on steps 14 and which extends into the polygonal profile opening 10 area by area.

The spring element, in particular the shrinkable tube 9, 9′, 9″ can be provided with an imprint, which specifies the wrench size.

The shrinkable tube preferably consists of polyethylene. For example, shrinkable tubes, which have a tensile strength of at least 10 MPa and the elongation at break of which is at least 200 percent, can be used. Preferably, the elongation at break lies in the range of between 250 percent and 350 percent. The shrink-fitting can thereby take place at temperatures of between 150 degrees Celsius and 200 degrees Celsius. The shrinkable tubes can have a material thickness of between 0.05 mm and 3 mm. The wall thickness increases in response to the shrink-fitting. The Shore hardness of the plastic coating should be in the range of between 64 and 65 D.

The above explanations serve to explain the inventions, which are captured by the application as a whole, which in each case further develop the prior art independently, at least by means of the following feature combinations, namely:

A socket spanner, which is characterized in that the spring element is a shrinkable tube, which is shrink-fitted on the wall.

A socket spanner, which is characterized in that the inner side of the shrinkable tube, which points to the window, is in contacting application with the retaining element.

A socket spanner, which is characterized in that the retaining element is a sphere and/or that the retaining element creates a bulge in the shrinkable tube.

A socket spanner, which is characterized in that the shrinkable tube is enclosed in a peripheral groove of the wall and/or that the shrinkable tube has a material thickness, which is only insignificantly smaller than the height of the edge of the peripheral groove.

A socket spanner, which is characterized in that the retaining element is located in the area between a center plane, which is placed through the axial center of the polygonal profile opening, and a bottom plane, which is placed through the bottom-side edge of the polygonal profile opening.

A socket spanner, which is characterized by two retaining elements, which are in particular arranged axially downstream from one another.

A socket spanner, which is characterized in that a first retaining element is located in the area of an opening plane, which is placed through the opening-side edge of the polygonal profile opening, and a center plane, which is placed through the axial center of the polygonal opening, and that a second retaining element is located in the area of the center plane and a bottom plane, which is placed through the bottom-side edge of the polygonal profile opening.

A socket spanner, which is characterized in that a second retaining element is located in the area between center plane and bottom plane.

A socket spanner, which is characterized in that a common spring element acts on the first retaining element and on the second retaining element.

A socket spanner, which is characterized in that the spring element is a shrinkable tube.

All of the disclosed features (alone) are essential for the invention. The disclosure content of the corresponding/enclosed priority documents (copy of the earlier application) is hereby also included in its entirety into the disclosure of the application, also for the purpose of adding features of these documents into claims of the instant application. In their optionally independent version, the subclaims characterize independent inventive further developments of the prior art, in particular for filing divisional applications on the basis of these claims.

1. A socket spanner comprising a drive head, which forms a polygonal profile opening, which can be plugged onto a polygonal bolt head or a polygonal screw nut, comprising a retaining element, which is enclosed in a window of the wall of the polygonal profile opening and which is acted on by a spring element, which is arranged outside the wall, characterized in that the spring element is a shrinkable tube, which is shrink-fitted on the wall.

2. The socket spanner according to claim 1, characterized in that the inner side of the shrinkable tube, which points to the window, is in contacting application with the retaining element.

3. The socket spanner according to claim 1, characterized in that the retaining element is a sphere

4. The socket spanner according to claim 1, precoding claims, characterized in that the retaining element creates a bulge in the shrinkable tube.

5. The socket spanner according to claim 1, characterized in that the shrinkable tube is enclosed in a peripheral groove of the wall.

6. The socket spanner according to claim 5, characterized in that the shrinkable tube has a material thickness, which is only insignificantly smaller than the height of the edge of the peripheral groove.

7. The socket spanner according to claim 1, preceding claims, characterized in that the retaining element is located in the area between a center plane, which is placed through the axial center of the polygonal profile opening, and a bottom plane, which is placed through the bottom-side edge of the polygonal profile opening.

8. The socket spanner according to claim 1, characterized by two retaining elements which are in particular arranged axially downstream from one another.

9. The socket spanner according to claim 1, characterized in that a first retaining element is located in the area of an opening plane, which is placed through the opening-side edge of the polygonal profile opening, and a center plane, which is placed through the axial center of the polygonal opening, and that a second retaining element is located in the area of the center plane and a bottom plane, which is placed through the bottom-side edge of the polygonal profile opening.

10. A socket spanner comprising a drive head, which forms a profile opening, which can be plugged onto a polygonal bolt head or a polygonal screw nut, comprising a first retaining element, which is enclosed in a window of the wall of the polygonal profile opening and which is acted on by a spring element, which is arranged outside the wall, wherein the opening edge of the polygonal profile opening defines an opening plane and the bottom-side side edge of the polygonal profile opening defines a bottom plane, and the first retaining element is located in the area between opening plane and a center plane, which is placed through the axial center between opening plane and bottom plane, characterized in that a second retaining element is located in the area between center plane and bottom plane.

11. The socket spanner according to claim 10, characterized in that a common spring element acts on the first retaining element and the second retaining element.

12. The socket spanner according to one of claim 10, characterized in that the spring element is a shrinkable tube.

13. (canceled)
